(19) United States
(12) Patent Application Publication
(10) Pub. No.: US 2017/0346773 A1
(43) Pub. Date: Nov. 30, 2017

(54) ELECTRONIC DEVICE AND METHOD FOR RECEIVING AND FORWARDING MESSAGES

(71) Applicants: Fu Tai Hua Industry (Shenzhen) Co., Ltd., Shenzhen (CN); HON HAI PRECISION INDUSTRY CO., LTD., New Taipei (TW)

(72) Inventors: FANG-HUA LIU, Shenzhen (CN); ZHE YANG, Shenzhen (CN)

(21) Appl. No.: 15/605,899

(22) Filed: May 25, 2017

(30) Foreign Application Priority Data
May 28, 2016 (CN) 201610360476.5

(51) Int. Cl. H04L 12/58; H04N 7/18

(52) U.S. Cl. CPC H04L 51/14; H04L 51/24; H04L 51/04; H04N 7/183; H04M 2250/12

(57) ABSTRACT

An electronic device capable of forwarding a message is provided. When the electronic device receives a message and determines that a user is not around, the electronic device transmits the received message to a second electronic device that the user is around. Therefore, the user will not miss important messages. A method for forwarding messages is also provided.

### CROSS-REFERENCE TO RELATED APPLICATIONS

This application claims priority to Chinese Patent Application No. 201610360476.5 filed on May 28, 2016.

### FIELD

The subject matter herein generally relates to information displaying, and particularly to a device and a method for displaying information in other devices.

### BACKGROUND

An intelligent electronic device, such as a smart phone, can receive a variety of messages, such as short messages, notifications of phone calls, push notifications. If the intelligent electronic device receives a message and an owner of the intelligent electronic device is not around, the owner may miss something important.

### BRIEF DESCRIPTION OF THE DRAWINGS

Implementations of the present technology will now be described, by way of example only, with reference to the attached figures.

FIG. 1 is a block diagram illustrating an exemplary embodiment of an operating environment of an electronic device for forwarding messages.

FIG. 2 is a block diagram illustrating an exemplary embodiment of a message receiving system running in a second electronic device communicating with the electronic device of FIG. 1.

FIGS. 3A-3B illustrating a flowchart of an exemplary embodiment of a method for forwarding messages.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”, it specifically indicates open-ended inclusion or membership in a so-described combination, group, series, and the like.

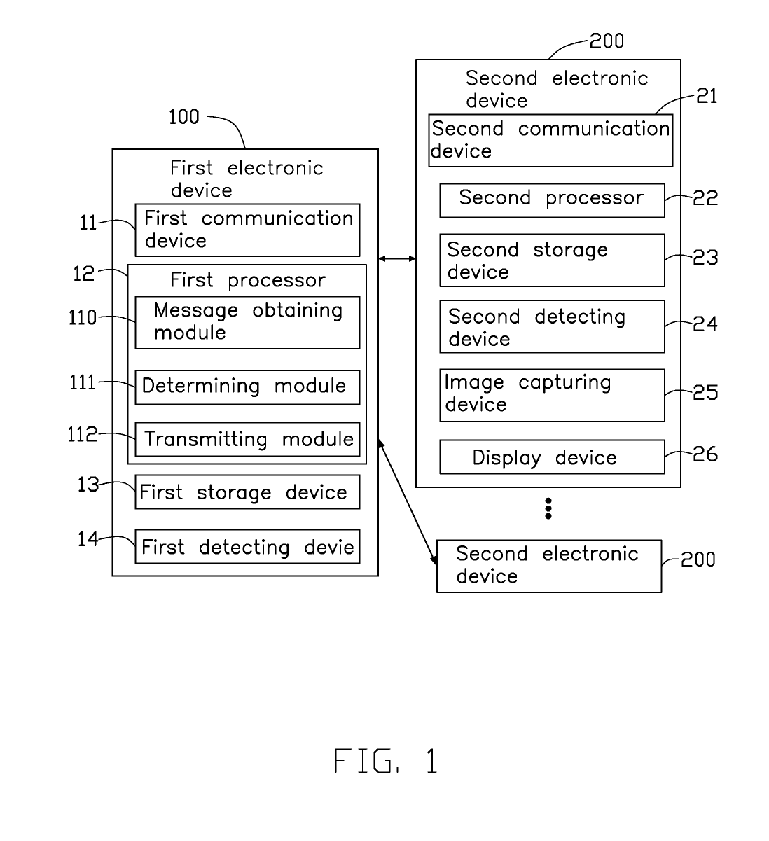

FIG. 1 illustrate an exemplary embodiment of an operating environment of a first electronic device 100 capable of forwarding messages. The first electronic device 100 can communicate with at least one second electronic device 200. If the first electronic device 100 receives a message and determines that the owner of the first electronic device 100 is not around the first electronic device 100, the first electronic device 100 transmits a signal to the at least one second electronic device 200 to control the second electronic device 200 to detect whether the owner of the first electronic device 100 is around the second electronic device 200. If determining that the owner of the first electronic device 100 is around the second electronic device, the first electronic device 100 forwards the message to the second electronic device 200. The second electronic device 200 displays the message to the user, thus the user will not miss important messages.

In the exemplary embodiment, the first electronic device 100 can be, but is not limited to, a smart phone or a tablet computer. The second electronic device 200 can be, but is not limited to, intelligent household appliances, such as televisions, air-conditions, refrigerators, microwave ovens, and the like. The message forwarded by the first electronic device 100 can be, but is not limited to, a short message, a notification of a phone call, a notification of a mail or an instant messenger, a push notification, or the like.

In the exemplary embodiment, the first electronic device 100 can include, but is not limited to, a first communication device 11, a first processor 12, a first storage device 13, and a first detecting device 14. The second electronic device 200 can include, but is not limited to, a second communication device 21, a second processor 22, a second storage device 23, a second detecting device 24, an image capturing device 25, and a display device 26.

The first communication device 11 can establish a communication with the second communication device 21 wirelessly or by wires. In the exemplary embodiment, the first communication device 11 and the second communication device 21 can be, but are not limited to, a BLUETOOTH module, a WI-FI module, or a ZIGBEE module. In the exemplary embodiment, the first processor 12 and the second processor 22 can be, but are not limited to, a central processing unit, a digital signal processor, or a single chip, for example. In the exemplary embodiment, the first storage device 13 and the second storage device 23 can be, but are not limited to, an internal storage system, such as a flash memory, a random access memory (RAM) for temporary storage of information, and/or a read-only memory (ROM) for permanent storage of information. The first storage device 13 and the second storage device 14 can also be a storage system, such as a hard disk, a storage card, or a data storage medium.

The first storage device 13 stores a facile image of the owner of the first electronic device 100. The second storage device 23 also stores the facile image of the owner of the first electronic device 100.

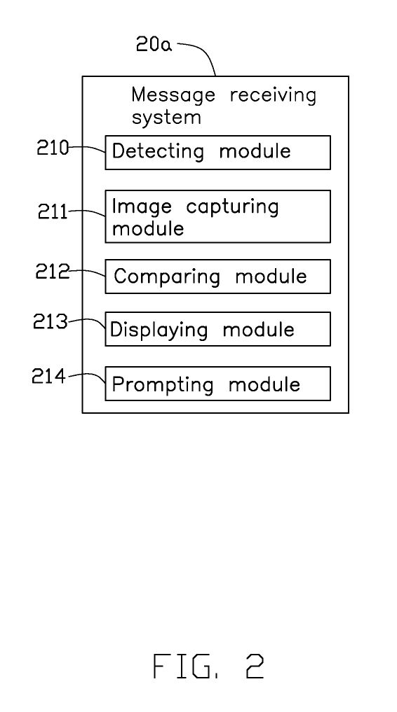

In the exemplary embodiment, the first storage device 13 further stores a number of modules, which are a collection of software instructions that can be respectively executed by the first processor 12. In the exemplary embodiment, the modules can include a message obtaining module 110, a determining module 111, and a transmitting module 112. Referring to FIG. 2, a message receiving system 20a is running in the second electronic device 200. The message receiving system 20a includes a number of modules, which are a collection of software instructions stored in the second storage device 23 and can be respectively executed by the second processor 22. In the exemplary embodiment, the modules can include a detecting module 210, an image capturing module 211, a comparing module 212, a displaying module 213, and a prompting module 214.

The message obtaining module 110 determines whether the first electronic device 100 receives a message, and obtains the message if determining that the first electronic device 100 receives the message. In the exemplary embodiment, the message obtaining module 110 determines whether the first electronic device 100 receives the message by determining whether a new message notification is generated.

If the message obtaining module 110 determines that the first electronic device 100 receives the message, the determining module 111 determines whether a user exists within a first preset range around the first electronic device 100 by using the first detecting device 14. For example, the first preset range can be three meters around the first electronic device 100. In the exemplary embodiment, the first detecting device 14 can be, but is not limited to, an infrared sensor.

If the determining module 111 determines that there is a user exists within the first preset range around the first electronic device 100, the determining module 111 controls the first electronic device 100 to display the message to the user. If the determining module 111 determines that there is nobody exists within the first preset range around the first electronic device 100, the determining module 111 generates a first control signal and transmits the first control signal to the at least one second electronic device 200 through the first communication device 11.

When receiving the first control signal, the detecting module 210 detects whether a user exists within a second preset range around the second electronic device 200 by using the second detecting device 24. In the exemplary embodiment, the second detecting device 24 can be, but is not limited to, a infrared sensor.

If the detecting module 210 determines that a user exists within the second preset range around the second electronic device 200, the image capturing module 211 controls the image capturing device 25 to capture a facile image of the user. In the exemplary embodiment, the image capturing device 25 can be, but is not limited to, a camera. The image capturing module 211 further stores the facile image of the user to the second storage device 23.

The determining module 111 determines which of the at least one second electronic device 200 is around the user.

In the exemplary embodiment, the method for the determining module 111 determining which of the at least one second electronic device 200 is around the user can include: the determining module 111 determines which of the at least one second electronic device 200 captures the facile image of the user by using a polling method. The determining module 111 determines one second electronic device 200 is around the user if determining that the second electronic device 200 captures the facile image of the user.

In an alternative embodiment, if the detecting module 210 determines that a user exists around the second preset range of the second electronic device 200, the detecting module 210 generates a feedback signal and transmits the feedback signal to the first electronic device 100 to inform the first electronic device 100 that there is a user exists around the second electronic device 200. In the embodiment, each second electronic device 200 includes an unique identification, the feedback signal includes the unique identification of the second electronic device 200. The determining module 111 determines which of the at least one second electronic device 200 is around the user according to the feedback signal.

The comparing module 212 compares the facile image of the user captured by the image capturing device 25 with the facile image of the owner of the first electronic device 100 stored in the second storage device 23 to determine whether the user around the second electronic device 200 is the owner of the first electronic device 100. If the facile image of the user captured by the image capturing device 25 matches the facile image of the owner of the first electronic device 100 stored in the second storage device 23, the comparing module 212 determines that the user around the second electronic device 200 is the owner of the first electronic device 100.

If the comparing module 212 determines that the user around the second electronic device is the owner of the first electronic device 100, the comparing module 212 transmits a second control signal to the first electronic device 100 through the second communication device 21.

If the transmitting module 112 determines that the second control signal is received from the second electronic device 100, the transmitting module 112 transmits the message to the second electronic device 200 that the user is around through the first communication device 11.

The displaying module 213 controls the display device 26 to display the message received from the first electronic device 100. In the exemplary embodiment, if the message received from the first electronic device 100 is a short message, the displaying module 213 controls the display device 26 to display a content of the short message and a phone number which sends the short message. If the phone number which sends the short message is stored in a phone book and is associated with a name of the user who sends the short message, the display device 26 further displays the name of the user. If the message received from the first electronic device 100 is a notification of a phone call, the displaying module 213 controls the display device 26 to display the phone number of the phone call, an attribution of the phone number, a call time, a name of the caller. If the message received from the first electronic device 100 is a push notification, the display module 213 controls the display device 26 to display the content of the push notification. In the exemplary embodiment, the display device 26 can be, but is not limited to, a Liquid Crystal Display.

The prompting module 214 generates a prompt information to prompt the user around the second electronic device 200 that a message is received and is needed to check.

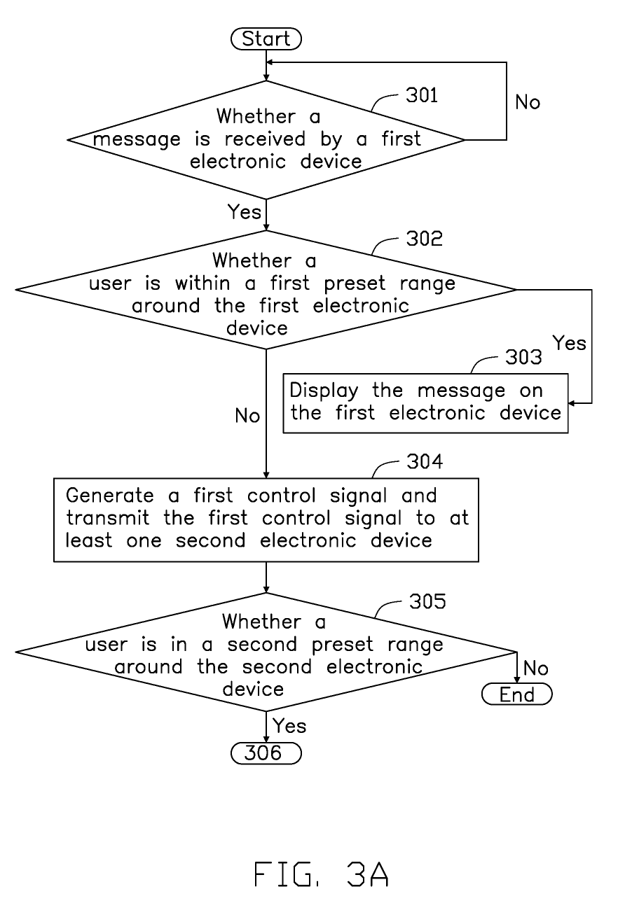

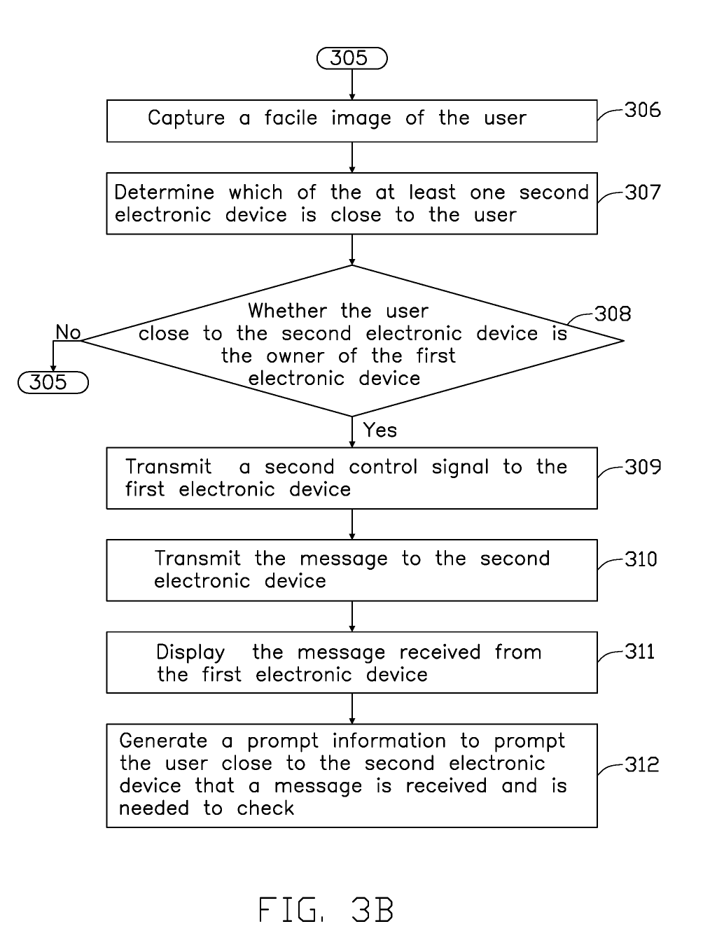

A method for forwarding a message is illustrated in FIGS. 3A-3B. The method is provided by way of example, as there are a variety of ways to carry out the method. Each block shown in FIGS. 3A-3B represent one or more processes, methods, or subroutines carried out in the example method. Additionally, the illustrated order of blocks is by example only and the order of the blocks can be changed. The example method can begin at block 301.

At block 301, a first electronic device determines whether a message is received. If yes, the procedure goes to block 302, otherwise, the procedures repeats block 301.

At block 302, the first electronic device determines whether a user exists within a first preset range around the first electronic device by using a first detecting device. For example, the first preset range can be three meters around the first electronic device. In the exemplary embodiment, the first detecting device can be, but is not limited to, an infrared sensor. If the first electronic device determines that there is a user exists within a first preset range around the first electronic device, the procedure goes to block 303, otherwise, the procedure goes to block 304.

At block 303, the first electronic device displays the message.

At block 304, the first electronic device generates a first control signal and transmits the first control signal to at least one second electronic device.

At block 305, the at least one second electronic device detects whether a user exists around a second preset range of the second electronic device by using a second detecting device. If the at least one second electronic device detects that a user exists within the second preset range around the second electronic device, the procedure goes to procedure 306, otherwise the procedure is end.

At block 306, the second electronic device captures an facile image of the user by using an image capturing device.

At block 307, the first electronic device determines which of the at least one second electronic device is around the user. In the exemplary embodiment, the method for determining which of the at least one second electronic device is around the user can include: determining which of the at least one second electronic device captures the facile image of the user by using a polling method. The first electronic device determines one second electronic device is around the user if determining that the second electronic device captures the facile image of the user. In an alternative embodiment, if the second electronic device determines that a user exists around the second preset range of the second electronic device, the second electronic device generates a feedback signal and transmits the feedback signal to the first electronic device to inform the first electronic device that there is a user exists around the second electronic device. In the embodiment, each second electronic device includes an unique identification, the feedback signal includes the unique identification of the second electronic device. The first electronic device determines which of the at least one second electronic device is around the user according to the feedback signal.

At block 308, the second electronic device compares the facile image of the user captured by the image capturing device with a pre-stored facile image of an owner of the first electronic device to determine whether the user around the second electronic device is the owner of the first electronic device. If determining that the user around the second electronic device is the owner of the first electronic device, the procedure goes to block 309, otherwise, the procedure goes back to block 305.

At block 309, the second electronic device transmits a second control signal to the first electronic device.

At block 310, the first electronic device transmits the message to the second electronic device.

At block 311, the second electronic device displays the message received from the first electronic device.

In the exemplary embodiment, the method further can include a block 312: the second electronic device generates a prompt information to prompt the user around the second electronic device that a message is received and is needed to check.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device for forwarding messages comprising:
a first communication device to communicate with at least one first electronic device;
a first detecting device;
at least one first processor; and
at least one first storage device storing one or more programs, when executed by the at least one first processor, the one or more programs cause the at least one first processor to:
determine whether a message is received;
detect whether a user exists within a first preset range around the electronic device by using the first detecting device if determining that the message is received;
determine which of the at least one first electronic device being around the user if determining that there is nobody exists within the first preset range around the electronic device; and
transmit the message to the at least one first electronic device which is around the user.

2. The electronic device of claim 1, wherein the at least one first processor determines whether the message is received by determining whether a new message notification is generated.

3. The electronic device of claim 1, wherein the first detecting device is an infrared sensor.

4. The electronic device of claim 1, wherein when receiving the message, the one or more programs further cause the at least one first processor to generate a first control signal and transmit the first control signal to the at least one first electronic device to enable the at least one first electronic device to detect whether the user exists within a second preset range around the at least one first electronic device.

5. An electronic device for receiving messages comprising:
a second communication device to communicate with at least one second electronic device;
a second detecting device;
an image capturing device to capture images;
a display device;
at least one second processor; and
at least one second storage device storing an facile image of an owner of the second electronic device, the at least one second storage device further storing one or more programs, when executed by the at least one second processor, the one or more programs cause the at least one second processor to:
determine whether a first control signal is received from the at least one second electronic device;
control the second detecting device to detect whether a user exists within a second preset range around the electronic device if the first control signal is received from the at least one second electronic device;
control the image capturing device to capture a facile image of the user if there is a user exists within the second preset range around the electronic device;
compare the facile image of the user captured by the image capturing device with the facile image of an owner of the at least one second electronic device stored in the at least one second storage device to determine whether the user around the electronic device is the owner of the at least one second electronic device;
generate a second control signal and transmit the second control signal to the at least one second electronic device to enable the at least one second electronic device to transmit a message to the electronic device; and
receive the message from the at least one second electronic device and display the message received from the at least one second electronic device on the display device.

6. The electronic device of claim 5, wherein if the at least one second processor determines that a user exists around the second preset range of the electronic device, the at least one second processor generates a feedback signal and transmits the feedback signal to the at least one second electronic device to inform the at least one second electronic device that there is a user exists around the electronic device.

7. The electronic device of claim 5, wherein the at least one second processor further generates a prompt information to prompt the user around the electronic device that a message is received from the at least one second electronic device.

8. A method for forwarding messages applied in a first electronic device and at least one second electronic device, the method comprising:
determining whether the first electronic device receives a message;
determining, by the first electronic device, whether a user exists within a first preset range around the first electronic device if determining that a message is received by the first electronic device;
transmitting a first control signal, by the first electronic device, to the at least one second electronic device;
detecting, by the at least one second electronic device, whether a user exists around a second preset range of the at least one second electronic device if the at least one second electronic device receives the first control signal;
capturing a facile image of the user by the at least one second electronic device if the user exists around the second preset range of the at least one second electronic device;
determining, by the first electronic device, which of the at least one second electronic device is around the user;
comparing, by the at least one second electronic device, the facile image of the user captured by the at least one second electronic device with a pre-stored facile image of an owner of the first electronic device to determine whether the user around the at least one second electronic device is the owner of the first electronic device; and
transmitting, by the first electronic device, the message to the at least one second electronic device if the user around the at least one second electronic device is the owner of the first electronic device.

9. The method for forwarding messages of claim 8, further comprising:
displaying the message on the at least one second electronic device.

10. The method for forwarding messages of claim 8, further comprising: generating a prompt information to prompt the user around the at least one second electronic device that a message is received and is needed to check.

11. The method for forwarding messages of claim 8, wherein the method for the first electronic device determining whether the message is received by determining whether a new message notification is generated.

12. The method for forwarding messages of claim 8, wherein if the at least one second electronic device determines that a user exists around the second preset range of the first electronic device, the at least one second electronic device generates a feedback signal and transmits the feedback signal to the first electronic device to inform the first electronic device that there is a user exists around the at least one second electronic device.

13. The method for forwarding messages of claim 8, wherein the first electronic device determines which of the at least one second electronic device captures the facile image of the user by using a polling method to determine which of the at least one second electronic device is around the user.
